(19) United States
(12) Patent Application Publication
(10) Pub. No.: US 2019/0286296 A1
(43) Pub. Date: Sep. 19, 2019

(54) INFORMATION PRESENTATION SYSTEM, INFORMATION PRESENTATION METHOD, AND NON-TRANSITORY COMPUTER READABLE MEDIUM

(71) Applicant: HONDA MOTOR CO., LTD., Tokyo (JP)

(72) Inventors: Naoki SHIBATA, Wako-shi (JP); Kazuya WATANABE, Wako-shi (JP); Kensuke KANAMORI, Wako-shi (JP)

(21) Appl. No.: 16/282,883

(22) Filed: Feb. 22, 2019

(30) Foreign Application Priority Data
Mar. 19, 2018 (JP) 2018-051149

(51) Int. Cl. G06F 3/0481; G06F 3/0482; G06F 16/9537

(52) U.S. Cl. CPC G06F 3/04817; G06F 16/9537; G06F 3/0482

(57) ABSTRACT

An information presentation system comprises: a determining unit that determines a recognition level indicating a degree of a user's recognition of a spot; and a presentation unit that changes a type of information about the spot to be presented to the user, according to the recognition level, and presents the information.

### CROSS-REFERENCE TO RELATED APPLICATION

This application claims priority to and the benefit of Japanese Patent Application No. 2018-051149 filed on Mar. 19, 2018, the entire disclosure of which is incorporated herein by reference.

### BACKGROUND OF THE INVENTION

### Field of the Invention

The present invention relates to an information presentation system, an information presentation method, and a non-transitory computer readable medium, and particularly to an information presentation technique in a mobile object.

### Description of the Related Art

Conventionally, so-called navigation systems for vehicles such as automobiles have a function of providing information on commercial facilities (for example, eating and drinking establishments) and other facilities located near a traveling route during traveling or the like.

For example, Japanese Patent Laid-Open No. 2012-145432 discloses a technique in which an in-vehicle navigation system presents pieces of POI information to be displayed on a map by ordering and outputting them according to a predetermined criterion.

On the other hand, the amount of information to be provided by a navigation system, such as the number of characters, may be affected and limited by a display area size or the like of the information. Therefore, vehicle drivers desire that in a limited area as described above, known information and redundant information about a spot to be omitted and information needed for themselves and information unknown to themselves to be preferentially provided.

### SUMMARY OF THE INVENTION

In the present invention, user convenience is improved by switching types of information to be provided to a user according to the user's recognition degree of a spot.

According to one embodiment of the present invention, an information presentation system includes: a determining unit that determines a recognition level indicating a degree of a user's recognition of a spot; and a presentation unit that changes a type of information about the spot to be presented to the user, according to the recognition level, and presents the information.

According to another embodiment of the present invention, an information presentation method includes: determining a recognition level indicating a degree of a user's recognition of a spot; and changing a type of information about the spot to be presented to the user, according to the recognition level, and presenting the information.

According to a further embodiment of the present invention, a non-transitory computer readable medium has stored thereon a program for causing a computer to function as: a determining unit that determines a recognition level indicating a degree of a user's recognition of a spot; and a presentation unit that changes a type of information about the spot to be presented to the user, according to the recognition level, and presents the information.

According to the present invention, user convenience can be improved by switching types of information to be provided to a user according to the user's recognition degree of a spot.

Further features of the present invention will become apparent from the following description of exemplary embodiments (with reference to the attached drawings).

### BRIEF DESCRIPTION OF THE DRAWINGS

FIG. 1 shows an example of a system configuration according to one embodiment of the present invention;

FIG. 2 shows an example of a hardware configuration of a terminal device loaded in a vehicle according to the present invention;

FIG. 3 shows an example of a hardware configuration of an information processing device according to the present invention;

FIG. 4 shows an example of a software configuration of a navigation system according to the present invention;

FIG. 5A is a diagram for illustrating a screen configuration according to the present invention;

FIG. 5B is a diagram for illustrating a screen configuration according to the present invention;

FIG. 6 is a diagram for illustrating recognition levels according to the present invention;

FIG. 7A shows a configuration example of data according to the present invention;

FIG. 7B shows a configuration example of data according to the present invention;

FIG. 8 is a flowchart of a process for setting a recognition level according to the present invention;

FIG. 9 is a flowchart of a display process according to the present invention; and

FIG. 10 is a diagram for illustrating a concept of information presentation according to a second embodiment.

### DESCRIPTION OF THE EMBODIMENTS

Hereinafter, embodiments according to the present invention will be described with reference to the drawings. It is noted that configurations and the like shown below are just examples, and the present invention is not limited thereto.

### First Embodiment

[System Configuration]

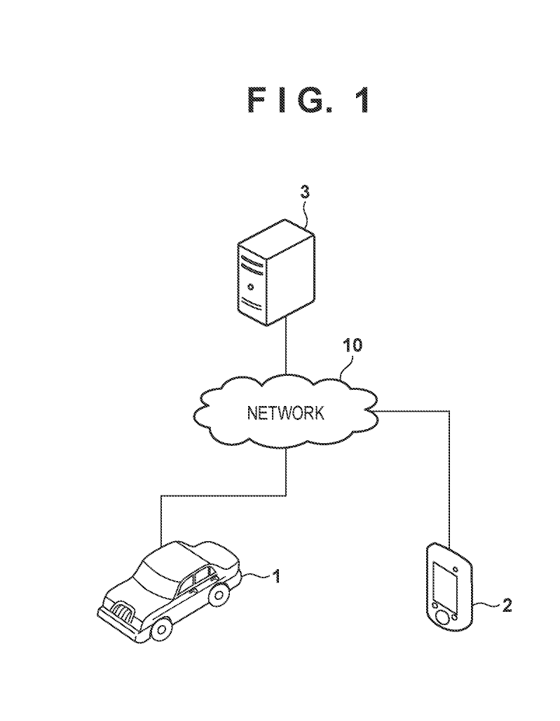

FIG. 1 shows an example of a system configuration according to the present embodiment. The system according to the present embodiment includes a vehicle 1, a mobile terminal 2, and a server 3. The vehicle 1, the mobile terminal 2, and the server 3 are communicably connected to each other through a network 10.

The vehicle 1 is mounted with an information processing terminal as a navigation system according to the present embodiment.

The mobile terminal 2 corresponds, for example, to a mobile phone, a smartphone, a mobile terminal or the like. The mobile terminal 2 includes a communication unit for communicating with an external device, a display unit for displaying various information, and an input unit for accepting a user's operation.

The server 3 is information processing device which performs various processing in response to requests sent from the vehicle 1 and the mobile terminal 2, and provides information thereto.

The network 10 corresponds, for example, to the Internet, but the types of communication standard, wired/wireless, and the like are not particularly limited. Each of the above described devices is illustrated as one device in FIG. 1, but is not limited thereto and may include a plurality of devices.

In the present embodiment, the navigation system as the information processing terminal mounted in the vehicle 1 is described as an example in the system configuration shown in FIG. 1, but the present invention is not limited thereto. For example, the mobile terminal 2 may be configured to function as a navigation system and used inside the vehicle. In addition, an application (not shown) installed in the mobile terminal 2 may provide a function as a navigation system in the mobile terminal 2.

[Hardware Configuration Example]

(Vehicle)

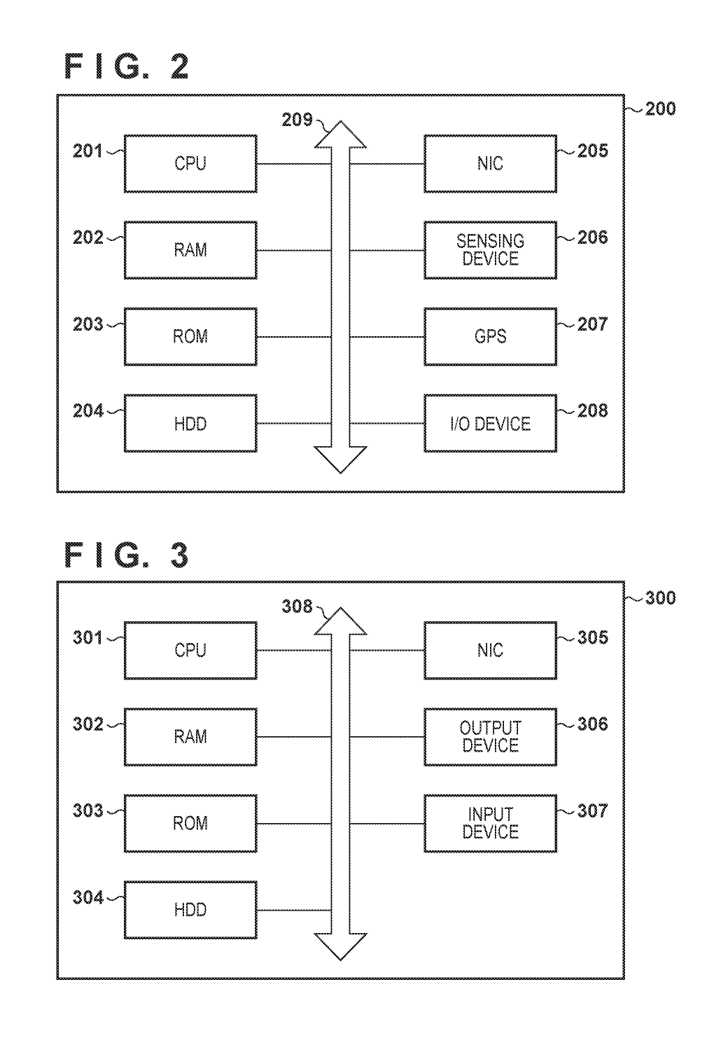

FIG. 2 shows an example of the hardware configuration of the information processing terminal provided in the vehicle 1 according to the present embodiment. In the hardware configuration shown in FIG. 2, only parts relating to information processing according to the present embodiment are shown, and for example, parts relating to movement (such as a steering and a brake) are omitted here. Further, the mobile terminal 2 is supposed to have a similar configuration, and a description thereof is omitted here.

The information processing terminal 200 includes a CPU 201, a RAM 202, a ROM 203, a HDD 204, a NIC 205, a sensing device 206, a GPS 207, and an I/O device 208. These units are communicably connected to each other through an internal bus 209. The CPU 201 is responsible for control of the overall information processing of the information processing terminal 200. The RAM (Random Access Memory) 202 is a volatile storage area used as a work memory and the like. The ROM (Read Only Memory) 203 is a nonvolatile storage area in which various programs and data are stored. The HDD (Hard Disk Drive) 204 is a nonvolatile storage area in which various data is stored. The NIC (Network Interface Card) 205 is responsible for communication with an external device through an external network (not shown), and transmits/receives various data. In the communication method used here, its communication system is not limited, and it may employ a wired or wireless system, and these may be combined.

The sensing device 206 corresponds, for example, to an imaging device such as a camera, a sensor for acquiring information around a mobile object, or the like. GPS (Global Positioning System) 207 acquires position information of the information processing terminal 200 (vehicle 1). The I/O device 208 displays various information, and receives an instruction from a user or the like. The I/O device 208 may have a configuration in which an input and an output are integrated such as in a touch panel display. Further, the I/O device 208 may include an output function using voice or the like.

(Server)

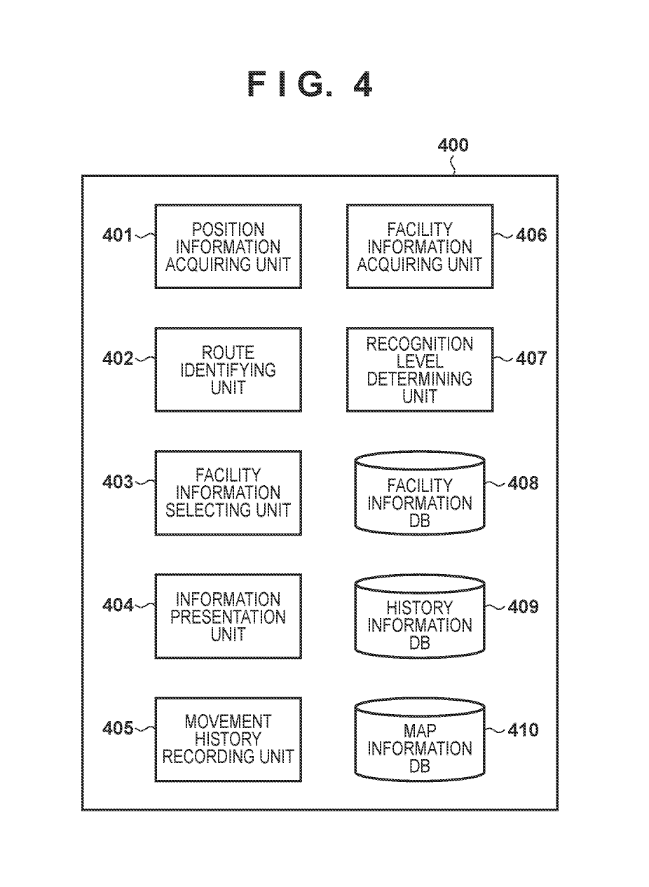

FIG. 3 shows an example of the hardware configuration of the information processing device functioning as the server 3 according to the present embodiment.

The information processing device 300 includes a CPU 301, a RAM 302, a ROM 303, an HDD 304, a NIC 305, an output device 306, and an input device 307. These units are communicably connected to each other through an internal bus 308. The CPU 301 is responsible for control of the overall processing of the information processing device 300. The RAM (Random Access Memory) 302 is a volatile storage area used as a work memory and the like. The ROM (Read Only Memory) 303 is a nonvolatile storage area in which various programs and data are stored. The HDD (Hard Disk Drive) 304 is a nonvolatile storage area in which various data is stored. The NIC (Network Interface Card) 305 is responsible for communication with an external device through an external network (not shown), and transmits/receives various data. In the communication method used here, its communication system is not limited, and it may employ a wired or wireless system, and these may be combined. The output device 306 outputs various data to external equipment. The output device 306 may include a display device such as a display. The input device 307 receives an input and an instruction from outside.

[Software Configuration]

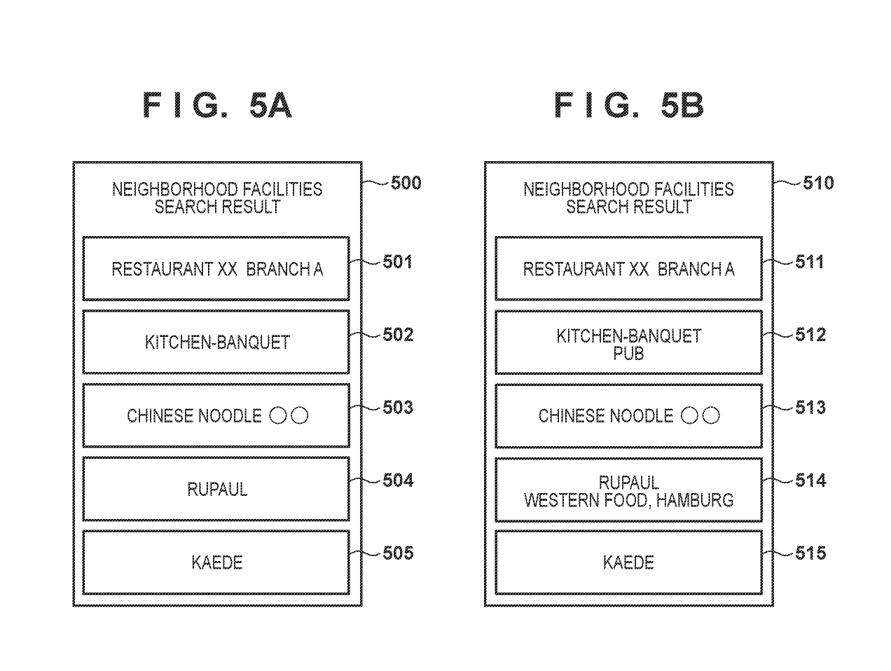

FIG. 4 shows an example of a software configuration of a navigation system 400 of the information processing terminal 200 mounted in the vehicle 1 according to the present embodiment. The navigation system 400 includes a position information acquiring unit 401, a route identifying unit 402, a facility information selecting unit 403, an information presentation unit 404, a movement history recording unit 405, a facility information acquiring unit 406, and a recognition level determining unit 407. The navigation system 400 further includes facility information DB 408, a history information DB 409, and a map information DB 410.

The position information acquiring unit 401 acquires the current position information of the information processing terminal 200 (vehicle 1). The current position is acquired from, for example, the GPS 207 included in the information processing terminal 200. The route identifying unit 402 identifies a route on which the vehicle 1 is traveling. Such a route may include information on a route to be traveled in the future. The facility information selecting unit 403 performs processing for selecting information to be presented to a user from information about each facility. Although an object to be provided as information by the navigation system 400 is described here as a “facility” for convenience, this may include various spots (POI: Point of Interest) such as a tourist spot, a park, and a natural spot in addition to a construction. The information presentation unit 404 presents various information selected by the facility information selecting unit 403. The presentation method used here may be switched between, for example, voice output and screen display depending on information to be presented or user setting. Further, history of presented information and information about history of access by a user to presented information are timely recorded as history information in the history information DB 409. The movement history recording unit 405 timely records information about movement of the information processing terminal 200 (vehicle 1) as movement history information in the history information DB 409. Such information about movement includes history of visits to a certain spot aside from traveling routes. The facility information acquiring unit 406 communicates with an external device (for example, the server 3) to acquire information about each facility. The information acquired here is stored in the facility information DB 408. The recognition level determining unit 407 determines a user's recognition level in association with each facility information stored in the facility information DB 408. A method for determining a recognition level will be described later.

The facility information DB 408 is a database for storing and managing information on a facility located in each spot such as commercial facility. The history information DB 409 is a database for storing and managing information about history of movement of the information processing terminal 200 (vehicle 1), and information provided by the navigation system 400, and information about history of access to such provided information. The map information DB 410 is a database for storing and managing map information including information and coordinates about roads and the like.

[Screen Configuration]

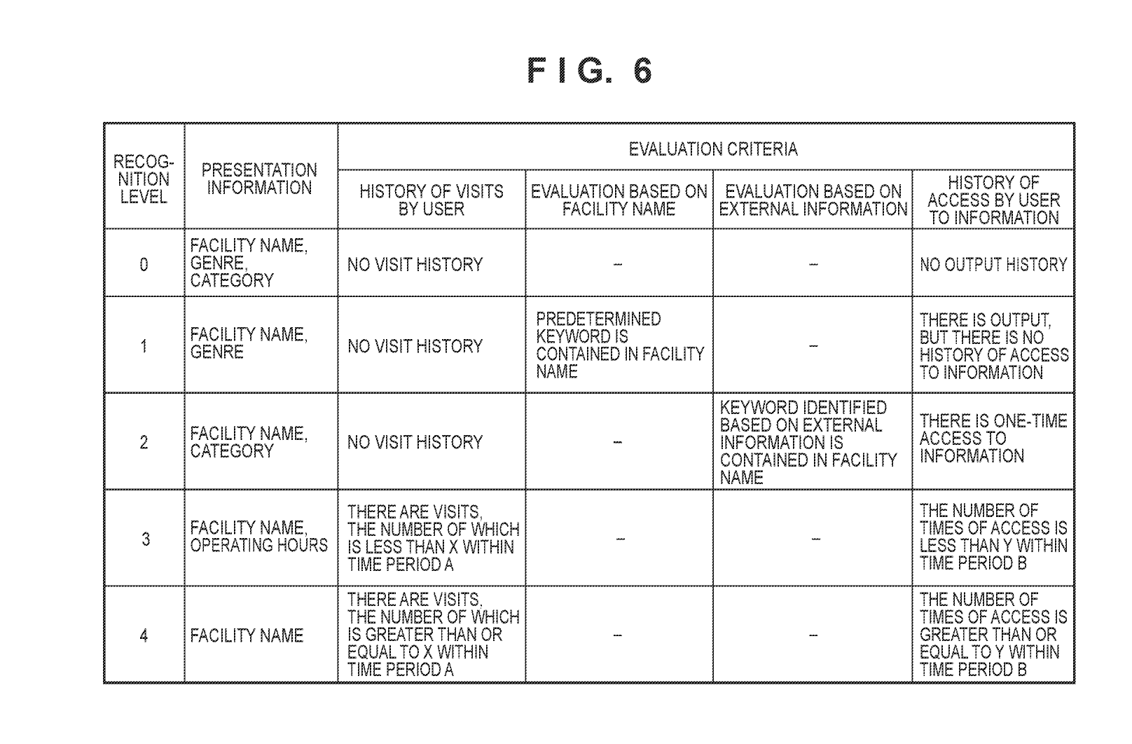

FIGS. 5A, 5B are diagrams for illustrating a screen configuration of the navigation system 400 according to the present embodiment. FIG. 5A shows an example in which information about neighborhood facilities is displayed in a screen by a conventional method. In this illustrated example, the navigation system 400 searches for the neighborhood facilities of the vehicle 1, and displays the search result in list form. In a screen 500, icons 501 to 505 about five facilities are displayed. For example, user can select any of the icons 501 to 505 to display further information (detailed information) about the facility corresponding to the selected icon.

On the other hand, FIG. 5B shows an example configuration of a screen 510 showing a display result of the navigation system 400 according to the present embodiment. Although the basic configuration is the same as in FIG. 5A, the display contents of some icons 512, 514 are different from those of FIG. 5A.

A description will be made while comparing FIG. 5A with FIG. 5B. In FIG. 5A, on each icon indicating information on a facility as a search result, only the name of the facility is displayed. On the other hand, in FIG. 5B, only facility names are displayed on the icons 511, 513, 515, whereas commercial facilities' genres and information on food to be served are displayed on the icons 512, 514, in addition to the facility name.

As shown in FIG. 5A and FIG. 5B, generally, in a navigation system mounted in a vehicle or the like, the area for displaying information is limited, so that the amount of information which can be presented at a time and the character size are limited. Therefore, assuming that information other than facility names as shown in the icons 512, 514 of FIG. 5B are displayed in all the icons, visibility thereof will be reduced. Further, for example, in a case where a facility name has already contained information on food to be served (“CHINESE NOODLES” in this example) as shown in the icon 503, to additionally display food information is redundant.

On the contrary, as shown in FIG. 5A, in a case where only facility names are displayed, the amount of information may be too small to indicate what each facility is. In this case, a method of displaying detailed information by selecting icons one by one may be used, but this method requires an instruction for each icon, and costs a user extra effort. For example, the type of the facility indicated by the icon 502 in FIG. 5A (for example, a western-style restaurant, a pub) cannot be understood at first glance. In this case, it is highly likely that the user will request for further information about the facility.

On the other hand, as for a facility visited by a user at multiple times, it is highly likely that the user has known information about the facility. By omitting information about such facilities, redundant display can be restrained. For example, it is assumed that a user has visited the facility of the icon 505 shown in the screen 500 in FIG. 5A at a certain number of times and known the information on this facility. Normally, the type of the facility cannot be understood at first glance only from the facility name displayed in the icon 505. However, since only the facility name is enough presentation if the user has known information on this facility, only the facility name is displayed as shown in the icon 515 of the screen 510 in FIG. 5B in the present embodiment.

Further, in the icon 501, the facility name contains a character string (keyword) indicating a branch name “BRANCH A”. In this case, it is highly likely that RESTAURANT XX is a branch of a chain, and its public recognition degree may be estimated to be a certain degree based on the number of commercial facilities of the chain. When the public recognition degree of the facility is a certain degree, it can be estimated that the user has known information about the facility to some extent.

In view of the above description, in a case where information output is limited, information to be output is switched depending on characteristics of a user and a facility in the present embodiment.

[Recognition Level]

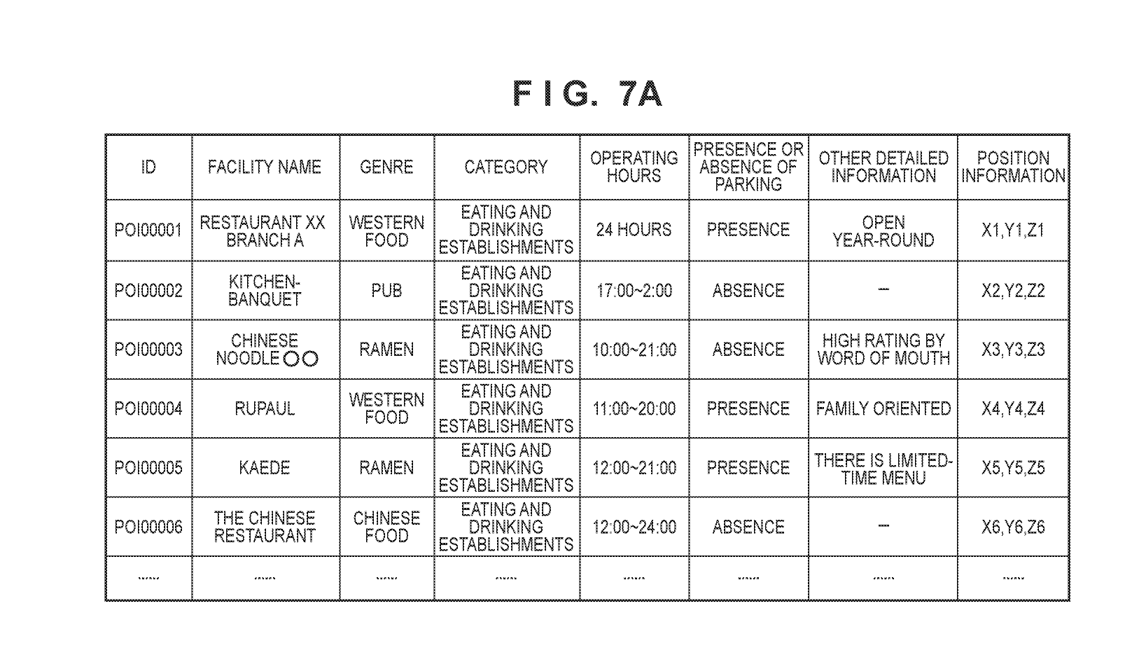

FIG. 6 is a diagram for illustrating recognition levels of facilities according to the present embodiment. The degree of a user's recognition of each facility varies depending on knowledge and experience of the user and public recognition of the facility. Accordingly, in the present embodiment, a user's recognition level is set with respect to each facility, and the content of information to be presented is switched according to the level. Classification and evaluation criteria illustrated in FIG. 6 are just an example, and the present invention is not limited thereto.

In FIG. 6, the recognition level is set to be one of five levels (0 to 4), and the degree of user's recognition of a facility increases as the value of the level increases. The user in this context is a user who uses the navigation system 400 (vehicle 1). Information to be output from the I/O device 208 is determined depending on the recognition level. For determining which recognition level each facility corresponds to, evaluation criteria have been defined. A plurality of evaluation criteria have been set, and evaluation can be performed based on history of user's actions (visits), history of access to information, information acquired from an external device (such as a server), etc. The evaluation criteria may be determined to be satisfied when one of the criteria is met or when all the criteria are met. Alternatively, a priority may be set to each evaluation criterion, and the evaluation criteria may be determined to be satisfied when a high-priority criterion is met. Items of presentation information to be presented corresponding to recognition levels are not limited to those shown in FIG. 6. For example, items of presentation information may be user-settable.

[Data Configuration]

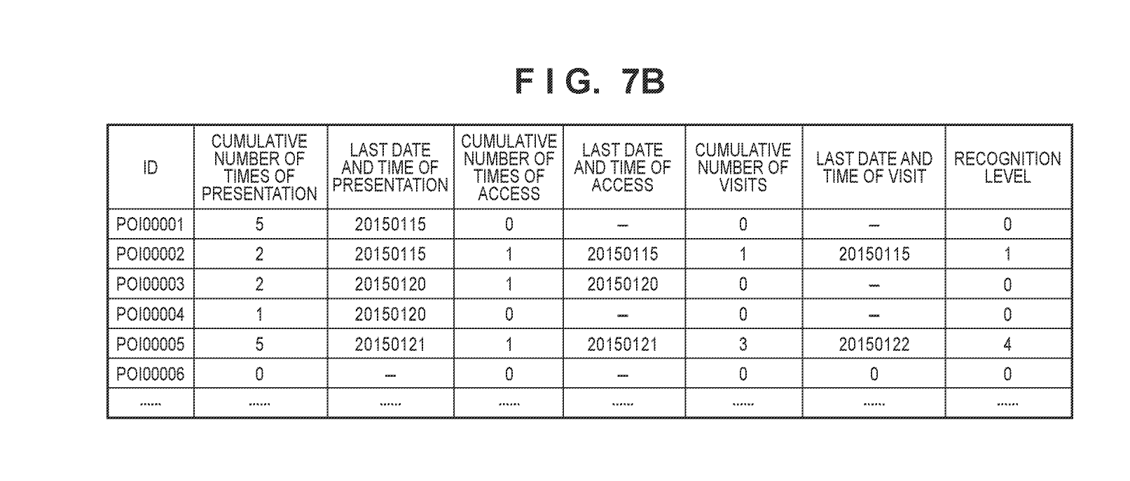

FIG. 7A and FIG. 7B show configuration examples of information managed by the navigation system 400 according to the present embodiment. FIG. 7A illustrates facility information about each facility, which is managed by the facility information DB 408. FIG. 7B illustrates history information, which is managed by the history information DB 409. The configurations of information shown as tables here are just an example, and may include other information. For example, image data of facilities may be included.

(Facility Information)

Facility information shown in FIG. 7A contains identification information for uniquely identifying a facility (ID), facility name, genre, category, operating hours, presence or absence of parking, other detailed information, and position information, in association with each other. Other information included in detailed information is not particularly limited, and further detailed classification may be made as necessary. Although “genre” and “category” are used as attribute information in this example, other attribute information may be included. Although operating hours and the presence or absence of parking are used as detailed information, other detailed information may be included. Further, attribute information and detailed information may be organized in a hierarchical structure. In this case, a hierarchical level of information to be presented may be selected according to a recognition level. Further, contents of facility information may be updated in a timely manner by acquiring information from an external device (for example, the server 3). In the present embodiment, information about a facility (spot) to be displayed to a user is selected from various kinds of information contained in facility information.

(History Information)

History information shown in FIG. 7B contains facility identification information (ID), the cumulative number of times of presenting facility information, the last date and time when facility information was presented, the cumulative number of times of access by a user to presented facility information, the last date and time when facility information was accessed, the number of visits to a facility, the last date and time when a facility was visited, and recognition level, in association with each other. Recognition levels are regularly updated based on the above described evaluation criteria. The identification information (ID) corresponds to the facility information in FIG. 7A. Visits to a facility may be identified based on the position information of the facility and the position information of the vehicle 1 (the information processing terminal 200), or may be updated based on input from a user.

[Process Flow]

(Recognition Level Setting Process)

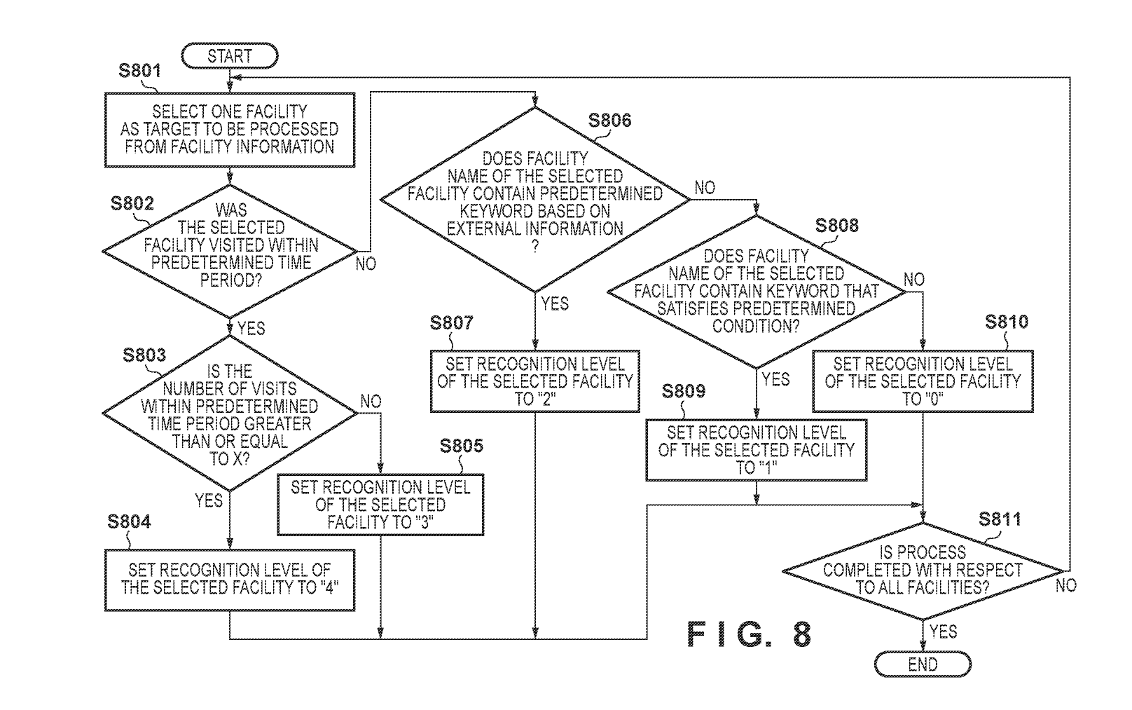

FIG. 8 is a flowchart of process for setting a recognition level of each facility according to the present embodiment. This process is realized by the CPU 201 of the information processing terminal 200 reading and executing a program stored in the ROM 203 or the like so as to act as the recognition level determining unit 407. Although the present embodiment will be described using some of the recognition level stages and evaluation criteria illustrated in FIG. 6 as an example, if a different number of level stages or a different evaluation criterion is used, decision in the process will be varied accordingly. This process is supposed to start at a predetermined timing or at regular intervals.

In S801, the CPU 201 selects one facility as a target to be processed from facility information stored in the facility information DB 408.

In S802, with reference to the facility information and history information corresponding to the facility selected in S801, the CPU 201 determines whether or not a user has visited the facility within a predetermined time period. The term “predetermined time period” in this context refers, for example, to a period backward from the current time, and the length of the period is predefined and stored as information. The process proceeds to S803 if it is determined that there has been any visit (YES in S802), and proceeds to S806 if it is determined that there has been no visit (NO in S802).

In S803, with reference to the facility information and history information corresponding to the facility selected in S801, the CPU 201 determines whether or not the user has visited the facility more than predetermined times X within the predetermined time period. It is assumed here that X has been predefined and the value of X has been stored. The process proceeds to S804 if the number of visits is greater than or equal to X (YES in S803), and proceeds to S805 if the number of visits is less than X (NO in S803).

In S804, the CPU 201 sets the recognition level of the facility selected in S801 to “4”. Thereafter, the process proceeds to S811.

In S805, the CPU 201 sets the recognition level of the facility selected in S801 to “3”. Thereafter, the process proceeds to S811.

In S806, the CPU 201 determines whether or not the facility name of the selected facility contains a predetermined keyword which is based on external information. The term “predetermined keyword” in this context refers, for example, to a keyword defined based on information acquired from an external device, which corresponds, for example, to a character string whose degree of public recognition is high. If a character string whose degree of public recognition is high is contained, the information about the facility is assumed to have been recognized also by the user to some extent. Examples of such keywords include a keyword used frequently by news and the like, and a keyword searched for many times on the Internet. The predetermined keyword may be, for example, stored as a dictionary in a storage unit and updated at a predetermined timing. The process proceeds to S807 if it is determined that the facility name contains the predetermined keyword (YES in S806), and proceeds to S808 if it is determined that the facility name does not contain the predetermined keyword (NO in S806).

In S807, the CPU 201 sets the recognition level of the facility selected in S801 to “2”. Thereafter, the process proceeds to S811.

In S808, the CPU 201 determines whether or not the facility name of the selected facility contains a keyword that satisfies a predetermined condition. The term “keyword that satisfies a predetermined condition” in this context corresponds, for example, to a keyword indicating an attribute of a facility, such as a keyword indicating a business content (including operating hours) of the facility or a keyword indicating a product to be provided. The predetermined condition is not limited to the above, and may be a different condition. The keyword may be, for example, stored as a dictionary in a storage unit and updated at a predetermined timing. The process proceeds to S809 if it is determined that the facility name contains the keyword (YES in S808), and proceeds to S810 if it is determined that the facility name does not contain the keyword (NO in S808).

In S809, the CPU 201 sets the recognition level of the facility selected in S801 to “1”. Thereafter, the process proceeds to S811.

In S810, the CPU 201 sets the recognition level of the facility selected in S801 to “0”. Thereafter, the process proceeds to S811.

In S811, the CPU 201 determines whether or not the process is completed with respect to all the facilities. If there are any unprocessed facilities (NO in S811), the process returns to S801 for selecting one facility as a target to be processed from the unprocessed facilities, and repeats. If processing is completed with respect to all the facilities (YES in S811), this process flow ends. As described above, the process is restarted after the elapse of a certain period of time after the process flow ends, or at the predetermined timing.

(Facility Information Display Process)

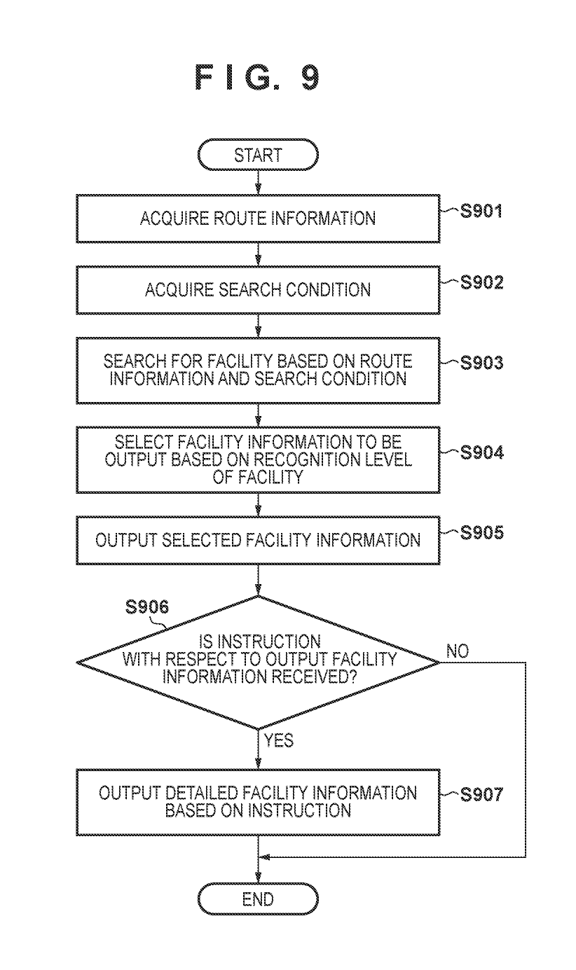

FIG. 9 is a flowchart of a process for displaying facility information according to the present embodiment. This process is realized by the CPU 201 of the information processing terminal 200 reading and executing a program stored in the ROM 203 or the like. This process may be triggered to execute by a user's instruction, or may be started at predetermined intervals while the vehicle 1 is traveling.

In S901, the CPU 201 acquires route information of the vehicle 1. This route information includes information such as on a current position of the vehicle 1 and a route to be traveled in the future.

In S902, the CPU 201 acquires a search condition of a facility. This search condition may be input by the user, or may be a predefined condition such as a distance from the current position of the vehicle 1 (information processing terminal 200).

In S903, the CPU 201 searches the facility information DB 408 for facility information for output, based on the acquired route information and search condition.

In S904, the CPU 201 selects information to be output, from the facility information on each facility extracted according to the search result in S903. In the present embodiment, information to be output is selected based on a recognition level, which has been set with respect to each facility information. For example, in the example of facility information shown in FIG. 7A, information to be output is selected from a facility name, a genre and a category as attribute information of the facility, operating hours and presence or absence of parking as detailed information of the facility, and the like.

In S905, the CPU 201 outputs the facility information selected in S904. For example, the screen display is made as shown in the screen 510 of FIG. 5B. If the number of facilities extracted as search results is more than the number of facilities that can be displayed at a time, facilities may be displayed in descending order of priority. Such priorities may be set in order from closest to the current position, or on a specific sorting condition, or the like.

In S906, the CPU 201 determines whether an instruction with respect to the output facility information is received or not. This instruction may be, for example, a depression of an icon corresponding to the facility or a voice instruction by a user. The process proceeds to S907 if an instruction is received (YES in S906). If no instruction is received (NO in S906), this process flow ends.

In S907, the CPU 201 outputs further information on the facility based on the instruction received in S906. For example, further detailed information about the facility information output in S905 may be output, or operation for switching output contents may be performed. Then, this process flow ends.

As described above, according to the present embodiment, user convenience can be improved by switching types of information to be provided to a user, in an environment such as a navigation system in which the amount of information to be output is limited.

### Second Embodiment

In the first embodiment, there has been described the configuration in which the amount (granularity) of information to be presented is changed according to a recognition level, in search result as illustrated in FIG. 5A and FIG. 5B. Further, there has been described a configuration in which detailed information about a relevant facility is presented when a further instruction with respect to search result is received, in S906, S907 in FIG. 9.

In the present embodiment, there will be described a configuration in which when a further instruction with respect to search result is received, detailed information about a relevant facility is further changed in granularity according to a recognition level. A description of a similar configuration to that of the first embodiment will be omitted.

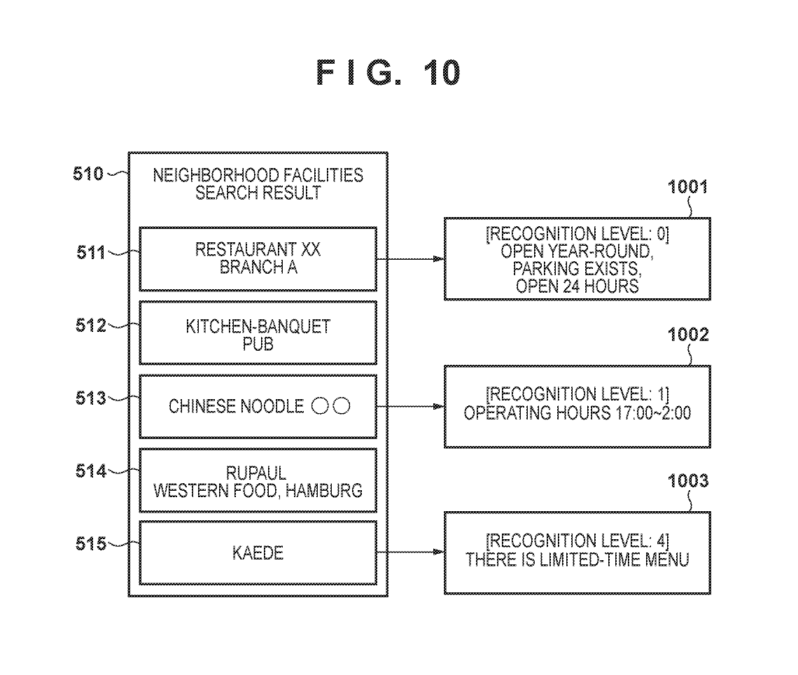

FIG. 10 is a diagram for illustrating a concept of information presentation according to the present embodiment. In the left side of FIG. 10, the screen 510 is shown as the same search result as in FIG. 5B. Further, facility information corresponding to each facility is similar to that shown in FIG. 7A and FIG. 7B.

The recognition level of the facility corresponding to the icon 511 has been set to “0”. In this situation, an instruction with respect to the icon 511 may be received from the user. This instruction may be a depression of the icon displayed on a touch panel screen or an instruction by user's voice. If the instruction is received, the navigation system 400 presents information illustrated as information 1001 among the facility information shown in FIG. 7A and FIG. 7B. The information may be presented by screen display or voice output.

Similarly, the recognition level of the facility corresponding to the icon 512 has been set to “1”. In this situation, if an instruction with respect to the icon 512 is received from the user, the information presentation device presents information illustrated as information 1002 among the facility information shown in FIG. 7A and FIG. 7B. Further, the recognition level of the facility corresponding to the icon 515 has been set to “4”. In this situation, if an instruction with respect to the icon 515 is received from the user, the information presentation device presents information illustrated as information 1003 among the facility information shown in FIG. 7A and FIG. 7B.

As described above, in the present embodiment, when further detailed information of a facility is requested by a user, contents of detailed information to be presented are selected according to a set recognition level and then presented. In the example illustrated in FIG. 10, in the case where the recognition level is “0” or “1”, the amount of information to be presented decreases as the recognition level is higher. Further, in the case where the recognition level is “4”, a different type of information (information about a menu in this example) is presented.

The type of and the number of items of information to be presented according to the recognition level are not particularly limited, and may be set depending on the type of facility and the like.

Additionally, in a case where after detailed information is presented, an instruction to present further detailed information is received from the user, then detailed information having a different content may be further presented. Additionally, an image may be displayed in addition to display of a character string and/or notification by voice.

As described above, according to the present embodiment, user convenience can be improved by switching types of detailed information to be provided according to user's recognition degree of a facility.

### Other Embodiments

In the above described embodiment, the configuration is described in which the information presentation device mounted in the vehicle performs processing, the present invention is not limited thereto. For example, a configuration as an information presentation system composed of a plurality of devices may be adopted in which part or all of the process of FIG. 8 is performed on the server side. In this case, data may be transmitted/received between the server and the vehicle (the information presentation device) in a timely manner, and the server may update user's recognition levels of facilities.

### Summary of Embodiments

1. An information presentation system (e.g., 400) according to any of the above described embodiments includes:

a determining unit (e.g., 407) that determines a recognition level indicating a degree of a user's recognition of a spot; and

a presentation unit (e.g., 403, 404) that changes a type of information about the spot to be presented to the user, according to the recognition level, and presents the information.

According to this embodiment, user convenience of information can be improved by switching types of information to be provided to a user according to the user's recognition degree of a spot.

2. In the information presentation system of the above described embodiment,

the determining unit determines the recognition level for each of a plurality of spots, and

the presentation unit changes a type of information about each of the plurality of spots to be presented to the user, according to the recognition level of a respective one of the plurality of spots.

According to this embodiment, user convenience of information can be improved by switching types of information to be provided to a user according to the user's recognition degree of each of a plurality of spots.

3. In the information presentation system of the above described embodiment,

the recognition level is determined based on an action history of the user.

According to this embodiment, an appropriate recognition level can be set based on an action history such as a history of visits by the user to the spot.

4. In the information presentation system of the above described embodiment,

the determining unit determines the user's recognition level of the spot to be higher as the number of visits by the user to the spot increases.

According to this embodiment, an appropriate recognition level can be set based on a history of visits by the user to the spot.

5. In the information presentation system of the above described embodiment,

in a case where the spot is a commercial facility,

the determining unit determines the recognition level of the spot based on information about public recognition of the commercial facility.

According to this embodiment, the recognition level is determined in consideration of the public's recognition of the commercial facility, so that more appropriate information presentation can be performed.

6. In the information presentation system of the above described embodiment,

the determining unit determines the recognition level of the spot according to the number of branches of a group to which the commercial facility belongs.

According to this embodiment, the recognition level is determined in consideration of popularization of a chain of commercial facilities or the like, so that more appropriate information presentation can be performed.

7. In the information presentation system of the above described embodiment,

the recognition level is determined according to a keyword contained in a name of the spot.

According to this embodiment, the recognition level is determined in consideration of the name of the spot, so that more appropriate information presentation can be performed.

8. In the information presentation system of the above described embodiment,

the keyword is defined based on information about public recognition.

According to this embodiment, the recognition level is determined in consideration of the public's recognition of a spot, so that more appropriate information presentation can be performed.

9. In the information presentation system of the above described embodiment,

the keyword is a character string indicating an attribute of the spot.

According to this embodiment, in a case where a keyword indicating an attribute of the spot is contained in the name of the spot, redundant information presentation about the attribute can be restrained.

10. In the information presentation system of the above described embodiment,

the presentation unit changes the number of types of information about the spot to be presented, according to the user's recognition level of the spot.

According to this embodiment, the number of types of information to be presented to the user can be switched according to the user's recognition level of the spot.

11. In the information presentation system of the above described embodiment,

as the user's recognition level of the spot becomes higher, the presentation unit decreases the number of types of information about the spot to be presented.

According to this embodiment, if the user's recognition level is high, redundant information presentation to the user can be restrained.

12. In the information presentation system of the above described embodiment,

types of information about the spot include a name of the spot, at least one attribute information about the spot, and at least one detailed information about the spot.

According to this embodiment, when information about a spot is selected, the information can be determined from a plurality of types of information.

13. In the information presentation system of the above described embodiment,

the presentation unit presents the information about the spot by at least one of voice and screen display.

According to this embodiment, a representation method can be selected from a plurality of presentation methods.

14. The information presentation system of the above described embodiment further includes a unit (e.g., 511 to 515) for receiving an instruction with respect to the spot about which the information has been presented by the presentation unit,

wherein the presentation unit further changes the type of the information about the spot to be presented to the user, according to the recognition level of the spot with respect to which the instruction has been received.

According to this embodiment, in a case where a request for information about a spot is received, the type of information to be presented is switched according to the recognition level, so that more appropriate information can be presented to the user.

15. An information presentation method according to any of the above described embodiments includes:

determining a recognition level indicating a degree of a user's recognition of a spot; and

changing a type of information about the spot to be presented to the user, according to the recognition level, and presenting the information.

According to this embodiment, user convenience of information can be improved by switching the granularity of information to be provided to a user according to the user's recognition degree of a spot.

16. A non-transitory computer readable medium according to any of the above described embodiments has stored thereon a program for causing a computer (e.g., 200) to function as:

a determining unit (e.g., 407) that determines a recognition level indicating a degree of a user's recognition of a spot; and

a presentation unit (e.g., 403, 404) that changes a type of information about the spot to be presented to the user, according to the recognition level, and presents the information.

According to this embodiment, user convenience of information can be improved by switching types of information to be provided to a user according to the user's recognition degree of a spot.

What is claimed is:

1. An information presentation system comprising:
a determining unit that determines a recognition level indicating a degree of a user's recognition of a spot; and
a presentation unit that changes a type of information about the spot to be presented to the user, according to the recognition level, and presents the information.

2. The information presentation system according to claim 1, wherein
the determining unit determines the recognition level for each of a plurality of spots, and
the presentation unit changes a type of information about each of the plurality of spots to be presented to the user, according to the recognition level of a respective one of the plurality of spots.

3. The information presentation system according to claim 1, wherein the recognition level is determined based on an action history of the user.

4. The information presentation system according to claim 3, wherein the determining unit determines the user's recognition level of the spot to be higher as a number of visits by the user to the spot increases.

5. The information presentation system according to claim 1, wherein in a case where the spot is a commercial facility, the determining unit determines the recognition level of the spot based on information about public recognition of the commercial facility.

6. The information presentation system according to claim 5, wherein the determining unit determines the recognition level of the spot according to a number of branches of a group to which the commercial facility belongs.

7. The information presentation system according to claim 1, wherein the recognition level is determined according to a keyword contained in a name of the spot.

8. The information presentation system according to claim 7, wherein the keyword is defined based on information about public recognition.

9. The information presentation system according to claim 7, wherein the keyword is a character string indicating an attribute of the spot.

10. The information presentation system according to claim 1, wherein the presentation unit changes a number of types of information about the spot to be presented, according to the user's recognition level of the spot.

11. The information presentation system according to claim 1, wherein as the user's recognition level of the spot becomes higher, the presentation unit decreases a number of types of information about the spot to be presented.

12. The information presentation system according to claim 1, wherein types of information about the spot comprise a name of the spot, at least one attribute information about the spot, and at least one detailed information about the spot.

13. The information presentation system according to claim 1, wherein the presentation unit presents the information about the spot by at least one of voice and screen display.

14. The information presentation system according to claim 1, further comprising a unit for receiving an instruction with respect to the spot about which the information has been presented by the presentation unit,
wherein the presentation unit further changes the type of the information about the spot to be presented to the user, according to the recognition level of the spot with respect to which the instruction has been received.

15. An information presentation method comprising:
determining a recognition level indicating a degree of a user's recognition of a spot; and
changing a type of information about the spot to be presented to the user, according to the recognition level, and presenting the information.

16. A non-transitory computer readable medium having stored thereon a program for causing a computer to function as:
a determining unit that determines a recognition level indicating a degree of a user's recognition of a spot; and
a presentation unit that changes a type of information about the spot to be presented to the user, according to the recognition level, and presents the information.
